(19) United States
(12) Patent Application Publication
(10) Pub. No.: US 2013/0122402 A1
(43) Pub. Date: May 16, 2013

(54) ELECTRODE FOR FUEL CELL, METHOD OF PREPARING THE ELECTRODE, CATALYST SLURRY, AND FUEL CELL INCLUDING THE ELECTRODE

(71) Applicants: Suk-gi Hong, Seongnam-si (KR); Yoon-hoi Lee, Hwaseong-si (KR); Jung-ock Park, Yongin-si (KR); Jin-su Ha, Seoul (KR)

(72) Inventors: Suk-gi Hong, Seongnam-si (KR); Yoon-hoi Lee, Hwaseong-si (KR); Jung-ock Park, Yongin-si (KR); Jin-su Ha, Seoul (KR)

(73) Assignee: SAMSUNG ELECTRONICS CO., LTD., SUWON-SI (KR)

(21) Appl. No.: 13/613,482

(22) Filed: Sep. 13, 2012

(30) Foreign Application Priority Data
Nov. 16, 2011 (KR) 10-2011-0119775

(51) Int. Cl. H01M 4/86; H01M 4/90; B01J 31/06; B01J 35/02; B01J 27/16; H01M 4/92; H01M 4/88; B82Y 30/00

(52) U.S. Cl. 429/524; 429/530; 429/532; 429/527; 429/526; 429/525; 427/115; 502/159; 502/100; 502/208; 977/742; 977/762

(57) ABSTRACT

An electrode for a fuel cell, a method of preparing the electrode, a catalyst slurry, and a fuel cell including the electrode. The electrode includes an electrode support and a catalyst layer formed on the electrode support, wherein the catalyst layer includes a catalyst material and a water-based binder, wherein the water-based binder is at least one selected from the group consisting of cellulose derivatives and composites of organic polymer materials and inorganic oxides.

### CROSS-REFERENCE TO RELATED APPLICATIONS

This application claims the benefit of Korean Patent Application No. 10-2011-0119775, filed on Nov. 16, 2011, in the Korean Intellectual Property Office, the disclosure of which is incorporated herein in its entirety by reference.

### BACKGROUND OF THE INVENTION

1. Field of the Invention

The present disclosure relates to electrodes for fuel cells, methods of preparing the electrodes, catalyst slurries, and fuel cells including the electrodes, and more particularly, to electrodes for fuel cells that include water-based binders, methods of preparing the electrodes, catalyst slurries, and fuel cells including the electrodes.

2. Description of the Related Art

In general, electrodes for fuel cells are fabricated by coating a catalyst slurry including a catalyst material, a binder, and an organic solvent on an electrode support and drying the coated electrode support.

However, when an electrode for a fuel cell is prepared using such an organic solvent, the drying time of the electrode is long. Moreover, this process is not environmentally friendly because the organic solvent is discharged, costs of the organic solvent are high, and equipment for exhausting the organic solvent (hood or oven) is needed. Therefore, there is a need to develop a method of preparing an electrode for a fuel cell, which is cost-efficient and environmentally friendly.

### SUMMARY

Provided are electrodes for fuel cells that include water-based binders.

Provided are methods of preparing electrodes for fuel cells.

Provided are catalyst slurries used in the preparation of electrodes for fuel cells.

Provided are fuel cells including the electrodes.

Additional aspects will be set forth in part in the description which follows and, in part, will be apparent from the description, or may be learned through practice of the presented embodiments by those skilled the art.

According to an aspect of the present disclosure, there is provided an electrode for a fuel cell that includes an electrode support; and a catalyst layer formed on the electrode support, wherein the catalyst layer includes a catalyst material and a water-based binder, wherein the water-based binder includes at least one selected from the group consisting of cellulose derivatives and composites of organic polymer materials and inorganic oxides.

The water-based binder may include a polyethylene oxide (PEO)-silica (SiO2) composite.

According to another aspect of the present disclosure, there is provided a method of preparing an electrode for a fuel cell that includes: coating or printing a catalyst slurry on an electrode support, wherein the catalyst slurry includes a catalyst material and a water-based binder, wherein the water-based binder includes at least one selected from the group consisting of cellulose derivatives and composites of organic polymer materials and inorganic oxides.

According to another aspect of the present disclosure, there is provided a catalyst slurry for a fuel cell that includes a catalyst material; a water-based binder; and a solvent, wherein the water-based binder includes at least one selected from the group consisting of cellulose derivatives and composites of organic polymer materials and inorganic oxides.

According to another aspect of the present disclosure, there is provided, a fuel cell that includes a cathode; an anode; and an electrolyte interposed between the cathode and the anode, wherein at least one of the cathode and the anode is the electrode described above.

Additional aspects and/or advantages of the disclosure will be set forth in part in the description which follows and, in part, will be obvious from the description, or may be learned through practice of the invention by those skilled in the art.

### BRIEF DESCRIPTION OF THE DRAWINGS

These and/or other aspects and advantages of the disclosure will become apparent and more readily appreciated from the following description of the embodiments, taken in conjunction with the accompanying drawings of which:

FIG. 1 is a graph showing the performance of each of the fuel cells manufactured according to Example 1 and Comparative Example 1;

FIG. 2 is a graph showing impedance measurement results in an air atmosphere of each of the fuel cells of Example 1 and Comparative Example 1;

FIG. 3 is a graph showing performance of each of the fuel cells manufactured according to Example 2 and Comparative Example 2;

FIG. 4 is a graph showing impedance measurement results in an air atmosphere of each of the fuel cells of Example 2 and Comparative Example 2; and

FIG. 5 is a graph showing the durability of the fuel cell of Example 2.

### DETAILED DESCRIPTION OF THE INVENTION

Reference will now be made in detail to the present embodiments of the present disclosure, examples of which are illustrated in the accompanying drawings, wherein like reference numerals refer to the like elements throughout. The embodiments are described below in order to explain the present invention by referring to the figures.

In this regard, the present embodiments may have different forms and should not be construed as being limited to the descriptions set forth herein. Accordingly, the embodiments are merely described below, by referring to the figures, to explain aspects of the present disclosure. Expressions such as “at least one of,” when preceding a list of elements, modify the entire list of elements and do not modify the individual elements of the list.

According to an embodiment of the present disclosure, an electrode for a fuel cell is provided that includes an electrode support and a catalyst layer formed on the electrode support, wherein the catalyst layer includes a catalyst material and a water-based binder, wherein the water-based binder includes at least one selected from the group consisting of cellulose derivatives and composites of organic polymer materials and inorganic oxides.

The term “water-based” as used herein refers to a property of strongly interacting with, having a strong affinity with, and being dissolved by, water and other polar substances. The term “composite” as used herein refers to a material made from two or more constituent materials having different physical or chemical properties which remain separate and distinct at the macroscopic or microscopic scale within the finished structure.

The catalyst material may include a carrier and a catalytic metal supported on the carrier.

The carrier may include at least one selected from the group consisting of carbon powder, carbon black, acetylene black, ketjen black, activated carbon, carbon nanotubes, carbon nanofibers, carbon nanowires, carbon nanohorns, carbon aerogels, carbon cryogels, and carbon nanorings.

The catalytic metal may include at least one selected from the group consisting of platinum (Pt), iron (Fe), cobalt (Co), nickel (Ni), ruthenium (Ru), rhodium (Rh), palladium (Pd), osmium (Os), iridium (Ir), copper (Cu), silver (Ag), gold (Au), tin (Sn), titanium (Ti), chromium (Cr), and alloys of at least two of these metals. The amount of the catalytic metal may be in the range of about 10 to about 1,000 parts by weight based on 100 parts by weight of the carrier. When the amount of the catalytic metal is within this range, the utilization of the catalytic metal is high and a fuel cell including the electrode will have high performance.

For example, the catalyst material may be an alloy of Pt and Co that is supported on carbon powder (PtCo/C).

The water-based binder acts as a binder for the catalyst material in an electrode prepared using the catalyst slurry. The water-based binder binds at least two of the catalyst materials to each other. In this regard, the water-based binder binds at least two carriers at positions between catalytic metals, not by covering the catalytic metals positioned on surfaces of carriers of the catalyst material. This binding method is desirable in an electrocatalytic reaction. In addition, it is desirable to use a water-based binder with excellent electrochemical stability, thermal stability and gas permeability.

The cellulose derivative may be at least one compound selected from the group consisting of carboxymethyl cellulose (CMC), methyl cellulose, hydroxyethyl cellulose, hydroxypropyl cellulose, hydroxyethyl methyl cellulose, and hydroxypropyl methyl cellulose.

The organic polymer material may be at least one compound selected from the group consisting of polyethylene oxide (PEO), polyvinyl alcohol (PVA), and styrenebutadiene rubber (SBR).

The inorganic oxide may be at least one compound selected from the group consisting of silica (SiO₂), titanium oxide (TiO₂), and zinc oxide (ZnO₂).

The water-based binder may be a PEO-SiO₂ composite. The PEO-SiO₂ composite has high hygroscopicity and durability.

The amount of the water-based binder may be in the range of about 0.1 to about 30 parts by weight based on 100 parts by weight of the catalyst material. When the amount of the water-based binder is within this range, it is easy to form a catalyst layer and a fuel cell including the electrode described above will have high performance.

According to another embodiment of the present disclosure, there is provided a method of preparing an electrode for a fuel cell that includes coating or printing a catalyst slurry on an electrode support, wherein the catalyst slurry includes a catalyst material and a water-based binder, wherein the water-based binder includes at least one selected from the group consisting of cellulose derivatives and composites of organic polymer materials and inorganic oxides.

The electrode support may be carbon paper or carbon cloth.

The electrode for a fuel cell may be prepared by coating or printing a catalyst slurry, which is described below, on an electrode support and then drying the coated electrode support to form a catalyst layer.

In the preparation of the electrode for a fuel cell, the drying process is not particularly limited, but may be performed by any general drying method at a temperature ranging from about 60° C. to about 150° C. or a freeze-drying method at a temperature ranging from about −20° C. to about −60° C.

The electrode for the fuel cell will exhibit high cell performance without having problems such as a high oxygen barrier or low oxygen permeability.

The catalyst slurry for the fuel cell includes the aforementioned catalyst material, a water-based binder, and a solvent.

The water-based binder is dissolved in the solvent to prepare a water-based binder solution, and the water-based binder solution may be used to prepare the catalyst slurry.

The solvent may include a water-based solvent and, optionally, an organic-based solvent.

In the catalyst slurry, the water-based solvent dissolves the water-based binder and disperses the catalyst material. The water-based solvent will also enable the catalyst slurry to have a suitable viscosity for electrode coating. The water-based solvent will naturally evaporate within a relative short period of time (e.g., 1 hour) without using a separate drying device (exhaust hood, drying oven, or the like). For example, if the water-based solvent includes alcohol, the drying time of the solvent after preparation of the electrode for the fuel cell will be shortened. In addition, when the water-based solvent includes alcohol, dispersability of the catalyst material in the catalyst slurry will be improved. This is considered due to the mutual attraction between the carbon chain or carbon ring of the alcohol with hydrophobicity and the carrier of the catalyst material with hydrophobicity. Also, the water-based solvent generally consists mostly of water and thus is cheap and environmentally friendly.

The water-based solvent may be at least one selected from the group consisting of water and alcohols.

The alcohol may be at least one of isopropyl alcohol (IPA) and ethanol.

The amount of the water-based solvent may be in the range of about 100 to about 2,000 parts by weight based on 100 parts by weight of the catalyst material. When the amount of the water-based solvent is within this range, smooth electrode coating will be performed.

The organic-based solvent will improve the dispersability of the catalyst slurry for a fuel cell.

The organic-based solvent may be at least one selected from the group consisting of N-methyl-2-pyrrolidone (NMP), N,N-dimethylacetamide (DMAc), and N,N-dimethylformamide (DMF).

The amount of the organic-based solvent may be appropriately adjusted within ranges such that the dispersability of the catalyst slurry for the fuel cell is improved, the water-based binder is completely dissolved in the solvent, manufacturing costs of the catalyst slurry for the fuel cell are not excessively increased, and the work environment of operators are not excessively aggravated.

The catalyst slurry for the fuel cell may further include phosphoric acid. When an electrode is prepared using the catalyst slurry for a fuel cell that includes phosphoric acid, the electrode including phosphoric acid that is uniformly dispersed from a surface of the electrode to inside the electrode will be obtained. Accordingly, unlike the general manufacturing process of an electrode, there is no need to perform a separate phosphoric acid-doping process on the surface of the electrode. In addition, a fuel cell manufactured using the electrode prepared as above will have improved cell performance thanks to a reduction in proton transfer resistance because of improvement of the enhanced dispersability characteristics of phosphoric acid in the electrode.

The amount of the phosphoric acid may be in the range of about 1 to about 1,000 parts by weight based on 100 parts by weight of the catalyst material. When the amount of the phosphoric acid is within this range, both proton transfer resistance and gas diffusion resistance will be maintained low.

The catalyst slurry for a fuel cell may further include a water repellent material. The water repellent material will prevent flooding in which an excess amount of electrolyte exists in the electrode and thus inhibits gas diffusion.

The water repellent material may be at least one selected from the group consisting of a 2,2-bistrifluoromethyl-4,5-difluoro-1,3-dioxoltetrafluoroethylene copolymer, polytetrafluoroethylene (PTFE), fluorinated ethylene propylene (FEP), polyvinylidenefluoride (PVdF), a vinylidenefluoride-hexafluoropropylene (PVDF-HFP) copolymer, and Fluorosarf (manufactured by Fluoro Technology).

The amount of the water repellent material may be in the range of about 0.1 to about 30 parts by weight based on 100 parts by weight of the catalyst material. When the amount of the water repellent material is within this range, flooding does not occur and a fuel cell including the electrode described as above will have high cell performance.

According to another embodiment of the present disclosure, there is provided a fuel cell includes a cathode, an anode, and an electrolyte interposed between the cathode and the anode, wherein at least one of the cathode and the anode is the electrode for a fuel cell as described above.

The electrolyte may include phosphoric acid. The phosphoric acid may be in a form impregnated on a thin film such as a polybenzimidazole film or a matrix such as a SiC matrix.

The term “fuel cell” as used herein refers to a fuel cell having an operating temperature of less than 200° C., and examples of the fuel cell include a solid polymer electrolyte membrane fuel cell (PEMFC), a direct methanol fuel cell (DMFC), an alkali fuel cell (AFC), and a phosphoric acid fuel cell (PAFC). The structures and manufacturing processes of these fuel cells are not particularly limited, and examples thereof are disclosed in a variety of documents in detail and thus a detailed description thereof is not provided herein.

One or more embodiments of the present disclosure will now be described in greater detail with reference to the following examples. However, these examples are for illustrative purposes only and are not intended to limit the scope of the invention.

### EXAMPLE

### Examples 1 and 2

### Preparation of Catalyst Slurries

PtCo/C (available from Tanaka Jewelry, Japan), a water-based binder, water, IPA, and 85 wt % of an aqueous phosphoric acid solution were mixed in amount ratios as shown in Table 1 below to prepare mixed solutions, and each mixed solution was then stirred at room temperature for 30 minutes to obtain a catalyst slurry.

TABLE 1

| | | Water-based binder | | | | Aqueous |
|---|---|---|---|---|---|---|
| | PtCo/ | | Amount | Water | IPA | phosphoric acid |
| | C (g) | Type | (g) | (g) | (g) | solution (g) |
| Example 1 | 1.0 | CMC | 0.02 | 3.0 | 4.0 | 1.0 |
| Example 2 | 1.0 | PEO-SiO₂ | 0.02 | 3.0 | 4.0 | 1.0 |

Preparation of Electrodes

The catalyst slurry prepared according to the above description was coated on carbon paper by using a wire bar and the coated carbon paper was then dried at 80° C. for 1 hour, at 120° C. for 30 minutes, and at 150° C. for 10 minutes to obtain an electrode. In this regard, the amounts of Pt per unit area of each of the electrodes of Examples 1 and 2 were 0.8 mg and 1.0 mg, respectively.

Manufacture of Fuel Cell

A fuel cell was manufactured using a cathode, an anode, and an electrolyte described below.

(1) Cathode

The electrode described above was cut to a size of 3.2 cm×3.2 cm and the cut electrode was used as a cathode.

(2) Anode

An electrode was prepared in the same manner as above, except that, in the preparation of the catalyst slurry, 1 g of PtRu/C (available from Tanaka Jewelry, Japan), 0.02 g of PVDF, and 6.0 g of NMP were used. The prepared electrode was cut to a size of 3.2 cm×3.2 cm and the cut electrode was used as an anode.

(3) Electrolyte

A polybenzimidazole membrane impregnated with 85 wt % of an aqueous phosphoric acid solution as an electrolyte was used.

### Comparative Examples 1 and 2

Electrodes were prepared in the same manner as in Examples 1 and 2, except that in the preparation of the catalyst slurries, PtCo/C (available from Tanaka Jewelry, Japan), polybenzimidazole, and N-methyl-2-pyrrolidone (NMP) were used in amount ratios as shown in Table 2 below. The amounts of Pt per unit area of each of the electrodes prepared according to Comparative Examples 1 and 2 were 0.8 mg and 1.0 mg, respectively.

TABLE 2

| | PtCo/C (g) | Polybenzimidazole (g) | NMP (g) |
|---|---|---|---|
| Comparative | 1.0 | 0.02 | 5.0 |
| Example 1 | | | |
| Comparative | 1.0 | 0.02 | 4.5 |
| Example 2 | | | |

Subsequently, each electrode was doped with 85 wt % of an aqueous phosphoric acid solution.

Thereafter, a fuel cell was manufactured in the same manner as in Examples 1 and 2 by using each of the electrodes of Comparative Examples 1 and 2.

### Evaluation Example

### Evaluation Example 1

### Evaluation of Cell Performance of Fuel Cell

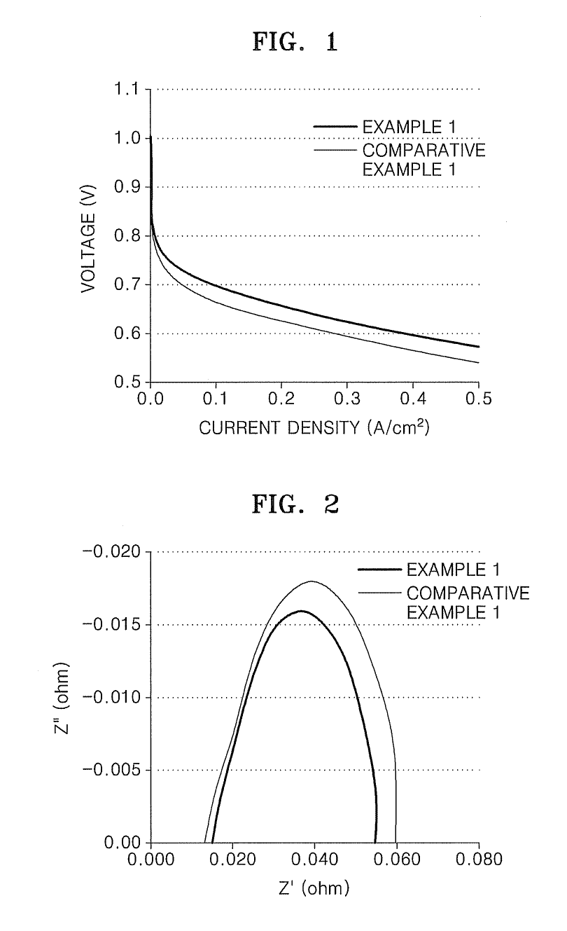

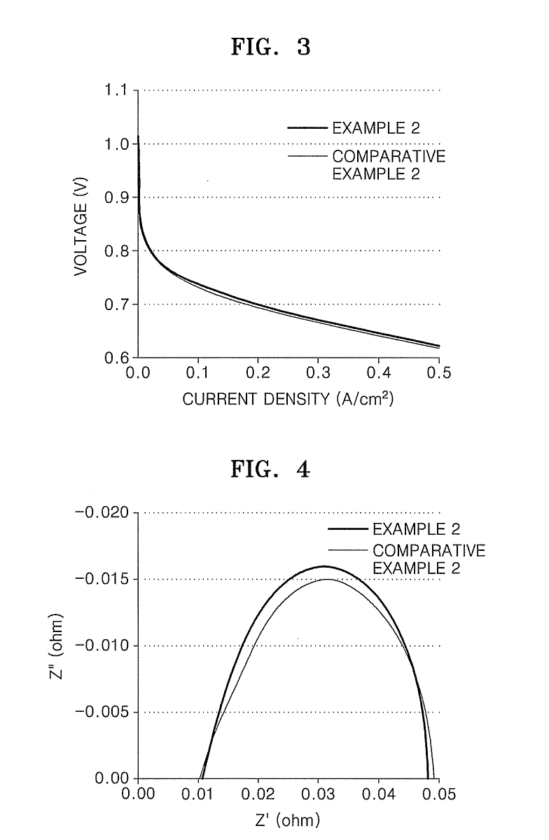

The performance of each of the fuel cells of Examples 1 and 2 and Comparative Examples 1 and 2 was evaluated as follows. The performance of each fuel cell was evaluated at 150° C. by using non-humidified air as an oxidizer for the cathode and non-humidified hydrogen as a fuel for the anode. In particular, the evaluation was performed by raising the current density step by step from 0 to 0.5 A/cm2 and recording the corresponding operating voltages. The performance of each of the fuel cells of Example 1 and Comparative Example 1 is illustrated in FIG. 1, and the performance of each of the fuel cells of Example 2 and Comparative Example 2 are illustrated in FIG. 3.

Referring to FIG. 1, the performance of the fuel cell of Example 1 is higher than that of the fuel cell of Comparative Example 1.

Referring to FIG. 3, the performance of the fuel cell of Example 2 is higher than that of the fuel cell of Comparative Example 2.

### Evaluation Example 2

### Impedance Evaluation of Fuel Cell

An alternating current impedance of each of the fuel cells of Example 1 and Comparative Example 1 was measured at a current density of 0.2 A/cm², and the measurement results are illustrated in FIG. 2. In addition, an alternating current impedance of each of the fuel cells of Example 2 and Comparative Example 2 was measured at a current density of 0.2 A/cm², and the measurement results are illustrated in FIG. 4.

In FIGS. 2 and 4, Z′ denotes the resistance and Z″ denotes the impedance.

In FIGS. 2 and 4, the impedance of each fuel cell is determined by the position and size of the semicircle. The first x-axis (i.e., horizontal axis) intercept of the semicircle denotes an electrolyte resistance (i.e., Ohmic resistance) and the difference between the first and second x-axis intercepts of the semicircle denotes the electrode resistance.

Referring to FIG. 2, the electrode resistance of the fuel cell of Example 1 is lower than that of the fuel cell of Comparative Example 1.

In addition, referring to FIG. 4, the electrode resistance of the fuel cell of Example 2 is lower than that of the fuel cell of Comparative Example 2.

### Evaluation Example 3

### Durability Evaluation of Fuel Cell

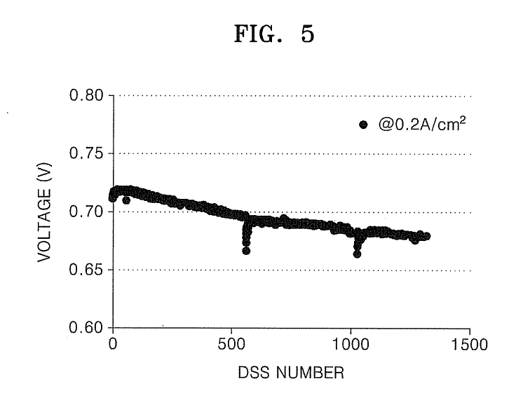

An operating voltage of the fuel cell of Example 2 was measured under daily start and stop (DSS) operation at a current density of 0.2 A/cm², and the results are illustrated in FIG. 5.

Referring to FIG. 5, the fuel cell of Example 2 exhibits 95% or greater of the maximum performance (i.e., maximum operating voltage) until the number of DSS operations reaches 1,300.

As described above, according to one or more of the above embodiments of the present disclosure, when an electrode is prepared using the catalyst slurry described above, the electrode will have improved performance, a phosphoric acid doping process need not be performed in the preparation of the electrode, equipment for drying the electrode is not needed, a drying time of an electrode will be shortened, the costs of an organic solvent used to prepare the electrode catalyst slurry will decrease, and the work environments of operators will be improved.

It should be understood that the exemplary embodiments described herein should be considered in a descriptive sense only and not for purposes of limitation. Descriptions of features or aspects within each embodiment should typically be considered as available for other similar features or aspects in other embodiments.

Although a few embodiments of the present disclosure have been shown and described, it would be appreciated by those skilled in the art that changes may be made in this embodiment without departing from the principles and spirit of the invention, the scope of which is defined in the claims and their equivalents.

What is claimed:

1. An electrode for a fuel cell, comprising:
an electrode support; and
a catalyst layer formed on the electrode support,
wherein the catalyst layer comprises a catalyst material and a water-based binder,
wherein the water-based binder comprises at least one member selected from the group consisting of cellulose derivatives, composites of organic polymer materials and inorganic oxides and mixtures thereof.

2. The electrode of claim 1, wherein the catalyst material further comprises a carrier and a catalytic metal supported on the carrier.

3. The electrode of claim 2, wherein the carrier comprises at least one member selected from the group consisting of carbon powder, carbon black, acetylene black, ketjen black, activated carbon, carbon nanotubes, carbon nanofibers, carbon nanowires, carbon nanohorns, carbon aerogels, carbon cryogels, and carbon nanorings.

4. The electrode of claim 2, wherein the catalytic metal comprises at least one member selected from the group consisting of platinum (Pt), iron (Fe), cobalt (Co), nickel (Ni), ruthenium (Ru), rhodium (Rh), palladium (Pd), osmium (Os), iridium (Ir), copper (Cu), silver (Ag), gold (Au), tin (Sn), titanium (Ti), chromium (Cr), and alloys of at least two thereof.

5. The electrode of claim 2 wherein the catalyst material is an alloy of Pt and Co that is supported on carbon powder (PtCo/C).

6. The electrode of claim 2 wherein the amount of the catalytic metal is in the range of about 10 to about 1,000 parts by weight based on 100 parts by weight of the carrier.

7. The electrode of claim 1, wherein the cellulose derivative comprises at least one compound selected from the group consisting of carboxymethyl cellulose (CMC), methyl cellulose, hydroxyethyl cellulose, hydroxypropyl cellulose, hydroxyethyl methyl cellulose, and hydroxypropyl methyl cellulose.

8. The electrode of claim 1, wherein the organic polymer material comprises at least one compound selected from the group consisting of polyethylene oxide (PEO), polyvinyl alcohol (PVA), and styrenebutadiene rubber (SBR).

9. The electrode of claim 1, wherein the inorganic oxide comprises at least one compound selected from the group consisting of silica (SiO₂), titanium oxide (TiO₂), and zinc oxide (ZnO₂).

10. The electrode of claim 1, wherein the water-based binder comprises a polyethylene oxide (PEO)-silica (SiO₂) composite.

11. The electrode of claim 1, wherein the amount of the water-based binder is in the range of about 0.1 to about 30 parts by weight based on 100 parts by weight of the catalyst material.

12. A method of preparing an electrode for a fuel cell, the method comprising coating or printing a catalyst slurry on an electrode support,
wherein the catalyst slurry comprises a catalyst material and a water-based binder,
wherein the water-based binder comprises at least one member selected from the group consisting of cellulose derivatives and composites of organic polymer materials and inorganic oxides.

13. The method of claim 12, wherein the water-based binder comprises a polyethylene oxide (PEO)-silica (SiO₂) composite.

14. The method of claim 12 wherein the catalyst slurry further comprises a solvent.

15. The method of claim 14 wherein said solvent comprises a water-based solvent.

16. The method of claim 15 wherein said water-based solvent is selected from the group consisting of water and alcohols.

17. The method of claim 16 wherein said alcohol is at least one of isopropyl alcohol (IPA) and ethanol.

18. The method of claim 15 wherein the amount of the water-based solvent is in the range of about 100 to about 2,000 parts by weight based on 100 parts by weight of the catalyst material.

19. The method of claim 15 wherein said solvent further comprises an organic-based solvent.

20. The method of claim 19 wherein said organic-based solvent is at least one selected from the group consisting of N-methyl-2-pyrrolidone (NMP), N,N-dimethylacetamide (DMAc), and N,N-dimethylformamide (DMF).

21. The method of claim 12 wherein the catalyst slurry further comprises phosphoric acid.

22. The method of claim 21, wherein the amount of phosphoric acid is in the range of about 1 to about 1,000 parts by weight based on 100 parts by weight of the catalyst material.

23. A catalyst slurry for a fuel cell, comprising:
a catalyst material;
a water-based binder; and
a solvent,
wherein the water-based binder comprises at least one selected from the group consisting of cellulose derivatives and composites of organic polymer materials and inorganic oxides.

24. The catalyst slurry of claim 23, further comprising phosphoric acid.

25. The catalyst slurry of claim 24, wherein the amount of the phosphoric acid is in a range of about 1 to about 1,000 parts by weight based on 100 parts by weight of the catalyst material.

26. The catalyst slurry of claim 23, wherein said solvent comprises a water-based solvent.

27. The catalyst slurry of claim 26, wherein said water-based solvent is selected from the group consisting of water and alcohols.

28. The catalyst slurry of claim 27, wherein said alcohol is at least one of isopropyl alcohol (IPA) and ethanol.

29. The catalyst slurry of claim 26, wherein the amount of the water-based solvent is in the range of about 100 to about 2,000 parts by weight based on 100 parts by weight of the catalyst material.

30. The catalyst slurry of claim 26, wherein said solvent further comprises an organic-based solvent.

31. The catalyst slurry of claim 36, wherein said organic-based solvent is at least one selected from the group consisting of N-methyl-2-pyrrolidone (NMP), N,N-dimethylacetamide (DMAc), and N,N-dimethylformamide (DMF).

32. A fuel cell comprising:
a cathode;
an anode; and
an electrolyte interposed between the cathode and the anode,
wherein at least one of the cathode and the anode is the electrode according to claim 1.
